(19) United States
(12) Patent Application Publication
(10) Pub. No.: US 2026/0016081 A1
(43) Pub. Date: Jan. 15, 2026

(54) OIL WETTING DEVICE FOR LUBRICATING MOTOR VEHICLE COMPONENTS, LUBRICATION DEVICE FOR TRANSMISSION COMPONENTS AND TRANSMISSION COMPONENT OF A VEHICLE

(71) Applicant: POLYTEC PLASTICS Germany GmbH & Co. KG, Lohne (DE)

(72) Inventor: Andreas JONITZ, Lohne (DE)

(21) Appl. No.: 19/261,091

(22) Filed: Jul. 7, 2025

(30) Foreign Application Priority Data
Jul. 9, 2024 (DE) 20 2024 103 798.7

(51) Int. Cl. F16H 57/04; F16N 7/32

(52) U.S. Cl. CPC F16H 57/046; F16H 57/0423; F16N 7/32; F16N 2210/04

(57) ABSTRACT

Oil wetting device (10) for lubricating motor vehicle components, comprising: an oil supply line (1) with an inlet end (11) for oil supply, and an oscillator device (2) for emitting an oscillating oil jet (3); wherein the oscillator device (2) is an oscillation chamber (20) with a drive nozzle (21) and with a discharge nozzle (22) located downstream of the drive nozzle (21); wherein the drive nozzle (21) is designed to discharge the oil supplied via the oil supply line (1) as a drive jet into the oscillation chamber (20); wherein geometric structures (23) for forming vortices are formed in the oscillation chamber (20), whereby the liquid drive jet is set into oscillation in a plane (30) as it flows through the oscillation chamber (20); and wherein the discharge nozzle (22) is designed to discharge the oil jet (3) oscillating in the plane (30) from the oscillation chamber (20).

### CROSS REFERENCE TO RELATED APPLICATIONS

The present application claims priority to German Patent Application 20 2024 103 798.7 filed Jul. 9, 2024, incorporated herein by reference.

According to a first aspect, the present invention relates to an oil wetting device for lubricating motor vehicles, according to a second aspect to a lubrication device for transmission components and according to a third aspect to a transmission component of a vehicle.

In the area of motor vehicle components, and in particular in the area of transmission components, it is necessary to provide comprehensive lubrication and cooling by applying an appropriate lubricant, such as transmission oil, to ensure operation with as little friction as possible. It is known from prior art, for example, to cool and lubricate gearwheels using punctiform nozzles that generate a point-shaped jet of lubricant or oil. In the case of punctiform nozzles, it is necessary to provide a plurality of corresponding nozzles for adequate lubrication and cooling of the transmission gears in order to achieve sufficient lubrication and cooling in the various areas of the transmission and to ensure this over the different operating states of the vehicle.

Furthermore, devices are also known from prior art with which an extensive oil film can be applied to transmission components, for example, which form a fan nozzle or a slot nozzle or a point nozzle with corresponding guide ribs to produce an extensive oil film. The above-mentioned devices for generating an extensive oil film all have the disadvantage that they require a high operating pressure of the lubricant or oil in order to generate a sufficiently extensive application via the corresponding nozzles. This is disadvantageous because, particularly in the field of electrically powered vehicles such as electric cars, the high operating pressure goes hand in hand with the requirement for high energy input from the pump delivering the lubricant. Furthermore, the above-mentioned devices for applying the extensive film of lubricant have the disadvantage that they cannot apply an extensive film of oil via the corresponding nozzles when the viscosity of the lubricant is increased, for example when it is not warmed up, such as in winter, due to the increased viscosity of the lubricant. There is therefore a risk that at lower lubricant temperatures, for example during a cold start of the vehicle in winter conditions, a sufficient supply of lubricant to the vehicle or transmission components cannot be achieved, which can lead to increased wear and a reduced service life of the transmission components.

Based on the aforementioned disadvantages of the prior art, it is an object of the present invention to provide a device for lubricating motor vehicle components, such as transmission components in particular, by means of which an extensive application of the lubricant can be produced even under low operating pressures of the lubricant and which, moreover, can still ensure adequate lubrication of the transmission components even at the lowest pump pressures for conveying the lubricant and a high existing viscosity of the lubricant.

According to a first aspect of the invention, the aforementioned problem is solved by an oil wetting device for lubricating motor vehicle components, in particular for lubricating transmission components. The oil wetting device according to the invention first has an oil supply line with an inlet end for supplying oil and an oscillator device for emitting an oscillating oil jet. The oscillator device comprises an oscillation chamber with a propelling nozzle and with a discharge nozzle located downstream relative to the propelling nozzle, wherein the propelling nozzle is designed to discharge the oil supplied via the oil supply line as a propelling jet into the oscillation chamber, wherein geometric structures are formed in the oscillation chamber to form vortices, whereby the liquid propelling jet is caused to oscillate in a plane when flowing through the oscillation chamber, and wherein the discharge nozzle is designed to discharge the oil jet oscillating in the plane from the oscillation chamber.

According to the invention, the term “oscillating oil jet”, which is emitted from the discharging nozzle, is understood to mean an oil jet which is not necessarily continuous and which, for example, is also interrupted or temporarily formed as immediately successive drops. According to the invention, however, the term “oscillating oil jet” is not to be understood as an oil mist, in particular not as an atomized lubricant mist. The term “oil” used herein refers to any lubricant that is used in the field of motor vehicle components, in particular in the field of transmission components for lubrication and preferably temperature control of the components. The oil is preferably a transmission oil.

The design of the oil wetting device according to the invention, in particular using an oscillation chamber in which a liquid propelling jet of the oil is caused to oscillate via geometric structures, has the advantage that the lubricant or oil can be caused to oscillate within the oscillation chamber even at very low operating pressures, since there is only a small pressure loss in the oscillation chamber. In the embodiment according to the invention, moving parts can be advantageously dispensed with. Furthermore, the oscillator device according to the invention enables the liquid propelling jet introduced into the oscillation chamber to pass through the oscillation chamber in a straight line at operating pressures of the oil which are below an oscillating excitation in the oscillation chamber. This makes it possible to ensure at least punctiform lubrication of the corresponding motor vehicle or transmission components in accordance with the invention, even at the lowest oil operating pressures.

Oscillator devices comprising an oscillation chamber for generating oscillating fluid jets have already become known from the prior art, in particular geometric structures within the corresponding oscillation chambers for generating oscillating fluid flows have already become known. As explained above, the oscillation chamber basically has a propelling nozzle for introducing a liquid propelling jet of the lubricant or oil into the oscillation chamber and a discharge nozzle, which is arranged downstream of the propelling nozzle in the oscillation chamber. The oscillation chamber has a pair of channels with inlet openings to the respective sides of the discharge nozzle and with corresponding outlet openings near the propelling nozzle, the oscillation chamber having a pair of wall surfaces beginning immediately downstream of the outlet openings and extending downstream thereof, the pair of wall surfaces defining two vortex-forming chambers, the upstream end of each of which is sufficiently recessed with respect to the outlet openings to avoid wall contact of the introduced oil, and in that the downstream end of each wall surface has respective projections with relatively smooth surfaces to guide the vortices formed in the vortex-forming chambers thereover and into the inlet opening, thereby causing the liquid propelling jet to oscillate back and forth in the oscillation chamber in a plane. The corresponding oscillating oil jet is then discharged from the oscillation chamber via the discharge nozzle and can then be applied to the surface of the corresponding vehicle components or transmission components to be lubricated.

In particular, the propelling nozzle can be designed as a point nozzle for emitting a concentrated liquid oil jet into the oscillation chamber. The point nozzle can have different geometric cross-sectional or nozzle shapes, such as square, trapezoidal or round.

As described above, at least two control channels located opposite each other in the oscillation chamber can be formed as geometric structures in the oscillation chamber. In a first exemplary embodiment, the opposing control channels can be formed mirror-symmetrically to a central axis, whereby it is achieved that a beam oscillating uniformly in two directions in the oscillation plane is generated. Otherwise, however, it is also preferable to design the opposing control channels asymmetrically or to provide the corresponding control channels with different flow cross-sections in order to generate non-uniform oscillation or oscillation in one main direction.

Preferably, the discharge nozzle can be designed in the form of a widening nozzle, such as a fan-shaped nozzle, wherein the corresponding fan nozzle is widened in a fan shape in the oscillation plane of the oil jet. However, it is also possible to design the discharge nozzle merely as an outlet hole with suitable cross-sectional dimensions for discharging the oscillating oil jet.

Any lubricant can be used as oil with the oil wetting device according to the invention, but in particular a transmission oil with low viscosity can be used.

Accordingly, it can be provided that the oil supply line as well as the oscillator device and their respective fluid-carrying components are made of a plastic material resistant to transmission oil and preferably reinforced with glass fiber. Preferably, thermoplastics can be used to form the device according to the invention and its components.

Preferably, it can be provided that the oil supply line and the oscillator device are made of polyamide 6 (polycaprolactam), which, as is particularly preferred, is glass fiber reinforced. It is again preferably provided that both the oil supply line and the oscillator device can be manufactured as plastic injection-molded parts.

The oil supply line can have an outlet end opposite the inlet end, wherein the oscillator device is molded to the oil supply line in the area of the outlet end with a material bond and wherein the propelling nozzle is formed at the outlet end of the oil supply line.

In an alternative embodiment, it can be provided that the oil supply line has an outlet end opposite the inlet end, wherein the oscillator device can be coupled to the oil supply line in a fluid-tight manner in the area of the outlet end. The fluid-tight coupling of the oscillator device to the outlet end of the oil supply line can, for example, be formed using clip or latching elements that are adapted to each other, whereby the oscillator device can be advantageously connected to the outlet end of the oil supply line. The coupling makes it possible in an advantageous way to change the position of the oscillation plane of the discharge nozzle or the fan nozzle of the oscillator device relative to the oil supply line. According to the invention, this makes it possible to form the oscillating oil jet in a desired plane and thus specifically directed at the transmission components to be wetted. The fluid-tight coupling of the oscillator device to the outlet end is preferably carried out without tools and reversibly.

The oil supply line and the oscillator device can again preferably be designed transversely to the direction of flow of the oil from the inlet end to the discharge nozzle as at least a two-shell injection-molded part with at least two plastic shell parts.

The at least two plastic shell parts are connected to each other in a fluid-tight manner via at least one joining surface or are connected to each other with a material bond to form a closed pipe structure in the area of the oil supply line and a fluid-tight oscillation chamber.

Preferably, the at least two-shell injection-molded plastic part has at least one flat joining surface.

It can be provided that the at least one first plastic shell part is formed from a laser-transparent plastic material and the at least one second plastic shell part is formed from a laser-absorbing plastic material. The aforementioned embodiment has the advantage that the first and second plastic shell parts can be connected or joined together in a fluid-tight manner by means of a laser welding process. Alternatively, it is also possible to form the first and second plastic shell parts generally from any plastic material and to join the corresponding plastic shell parts by means of an assembly injection molding process.

The at least two plastic shells can be joined together, preferably with a material bond. It can also be provided that the at least two plastic shell parts are glued together.

Preferably, it can be provided that, along the direction of flow of the oil from the inlet end to the discharge nozzle, the oil supply line and the oscillator device are each designed as an integral plastic injection-molded part.

Furthermore, it can be provided that a quick-coupling connection is formed in the area of the inlet end of the oil supply line for fluid-tight coupling of the oil wetting device according to the invention to an oil-carrying component.

It can also be provided that a sealing element is arranged or molded in the area of the inlet end and/or, if present, the outlet end of the oil supply line, preferably designed for fluid-tight coupling of the oil supply line.

In the area of the oil supply line and/or the oscillator device, at least one fastening element, preferably a threaded sleeve, can also be provided for the load-bearing connection of the oil wetting device according to the invention to a motor vehicle component or a transmission component.

The threaded sleeve is used to specify a screw point to absorb the screw load in a component.

According to a second aspect, the present invention relates to a lubrication device for transmission components, preferably of an electrically driven vehicle, wherein the device comprises at least one transmission component of a vehicle, at least one oil-carrying component and at least one oil wetting device according to the first aspect of the present invention, wherein the at least one inlet end of the at least one oil wetting device is connected to the at least one oil-carrying component for supplying oil into the at least one oil supply line, and wherein the at least one discharge nozzle is directed towards the at least one transmission component for discharging an oscillating oil jet onto the transmission component.

According to a third aspect, the present invention relates to transmission component of a vehicle, preferably an electrically driven vehicle, comprising at least one oil-carrying component and at least one oil wetting device according to the first aspect of the present invention, wherein the at least one inlet end of the at least one oil wetting device is connected to the at least one oil-carrying component for supplying oil into the at least one oil supply line, and wherein the at least one discharge nozzle is directed towards the at least one transmission component for discharging an oscillating oil jet onto the transmission component.

In the following, exemplary embodiments of the device of the invention are explained with reference to the accompanying Figures.

The Figures show:

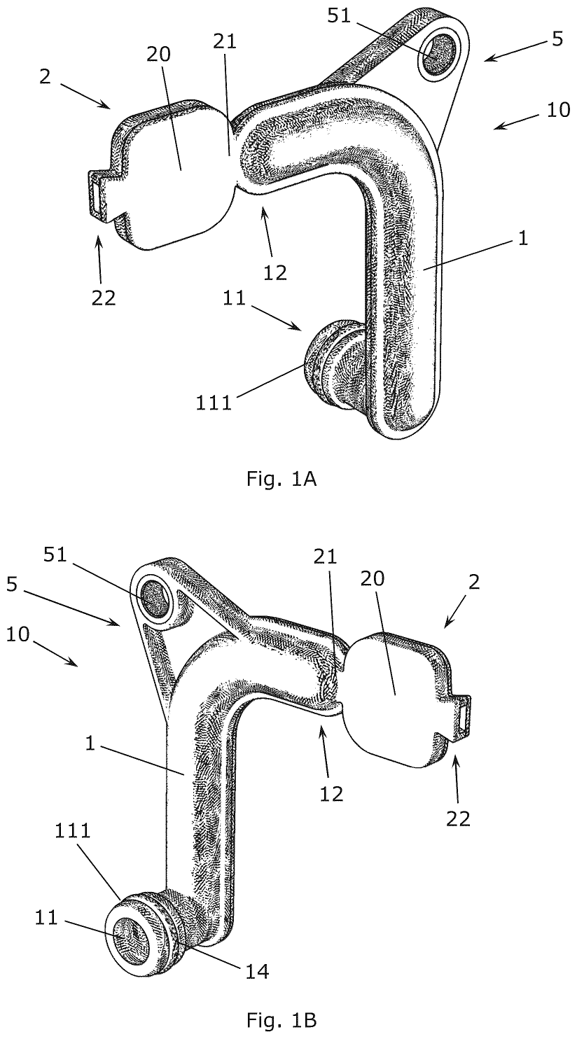

FIG. 1A a first perspective schematic view of the front of an oil wetting device according to the invention;

FIG. 1B the exemplary embodiment of the oil wetting device according to FIG. 1A in perspective view from the rear;

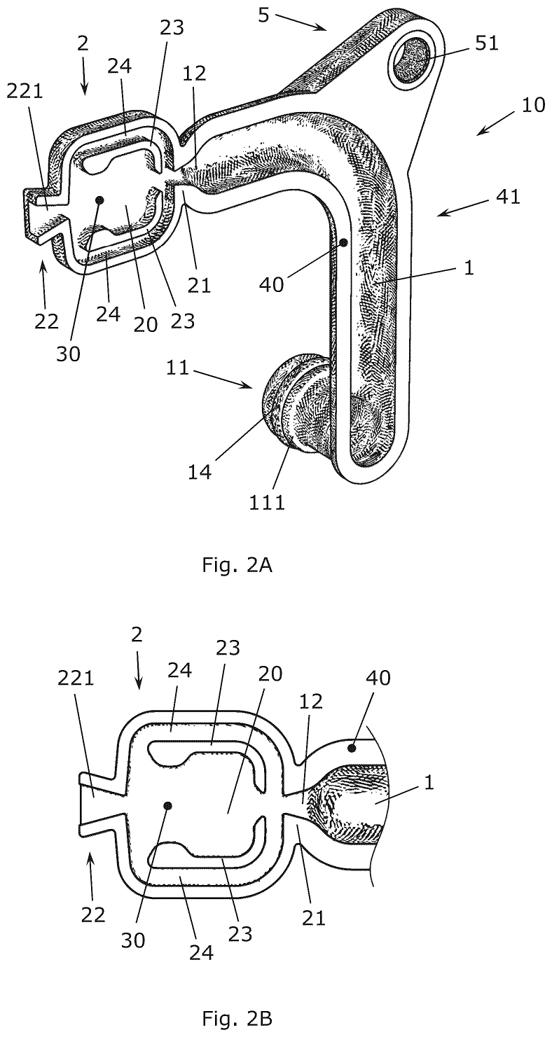

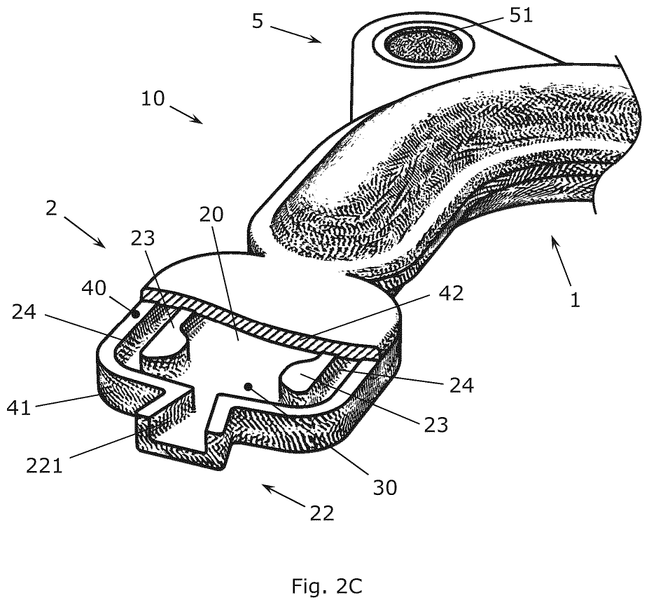

FIG. 2A a second exemplary embodiment of a first half-shell of an oil wetting device according to the invention in half-shell design;

FIG. 2B an enlarged schematic view of the embodiment according to the invention as shown in FIG. 2A in the area of the oscillation chamber;

FIG. 2C the exemplary embodiment of the oil wetting device according to the invention as shown in FIG. 2A with the second half-shell attached, which is partially cut free in the front area;

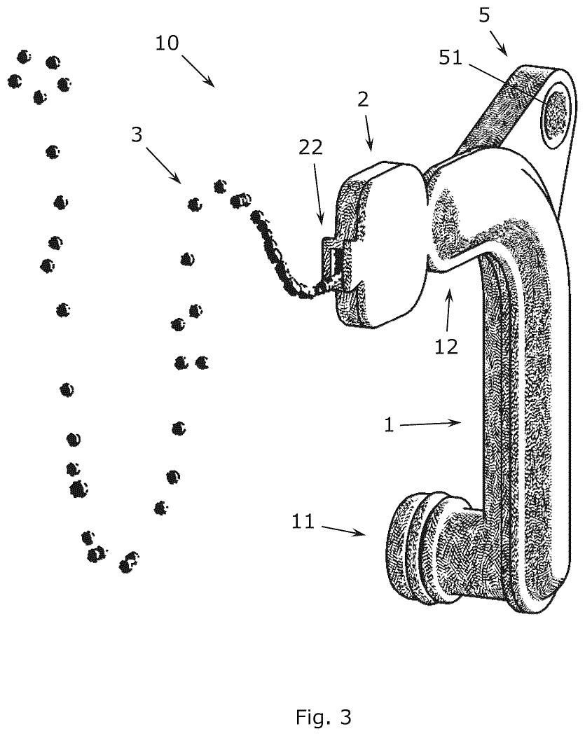

FIG. 3 the exemplary embodiment of an oil wetting device according to the invention as shown in FIGS. 1A and 1B with a schematically depicted oil jet; and

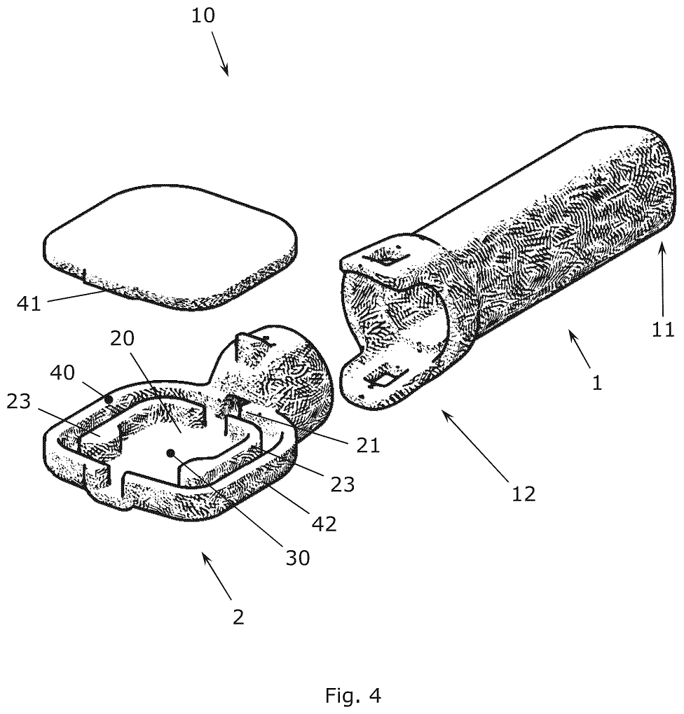

FIG. 4 is a perspective view of a further exemplary embodiment of an oil wetting device according to the invention.

FIG. 1A shows in perspective and schematic view a first front view of an oil wetting device 10 according to the invention, which is provided for lubricating motor vehicle components, in particular transmission components, by emitting an oscillating oil jet. The oil wetting device 10 according to the invention comprises an oil supply line 1 with an inlet end 11 for supplying oil and an oscillator device 2 for emitting an oscillating oil jet, wherein the oil jet is not shown in FIG. 1A, but can be taken as an example from FIG. 3 and bears the reference numeral 3.

The oscillator device 2 has an oscillation chamber 20 with a propelling nozzle 21 and a discharge nozzle 22 located downstream relative to the propelling nozzle 21. The propelling nozzle 21 is designed to discharge the oil supplied via the oil supply line 1 as a propelling jet into the oscillation chamber 20, wherein geometric structures 23 are formed in the oscillation chamber 20, as can be seen from FIG. 2A, to form vortices within the oscillation chamber 20, wherein the vortices cause the liquid propelling jet to oscillate in a plane 30 as it flows through the oscillation chamber 20. The discharge nozzle 22 is designed in such a way that it is suitable for discharging the oil jet 3 oscillating in the plane 30 from the oscillation chamber. The exemplary embodiment of the oil wetting device according to FIG. 1 is designed in such a way that the oil supply line 1 has an outlet end 12 opposite the inlet end 11, wherein in the region of the outlet end 12 in the illustrated embodiment according to FIG. 1, the oscillator device 2 is formed on the oil supply line 1 with a material bond and wherein the propelling nozzle 21 is formed on the outlet end 12 of the oil supply line, as can also be seen in more detail in FIG. 2A.

The exemplary embodiment according to FIG. 1A and FIG. 1B also has an optional quick coupling connection 111 in the area of the inlet end 11 of the oil supply line 1, which is designed for fluid-tight coupling of the oil supply line 1 to an oil-carrying component. A sealing element 14 is arranged or formed in the area of the inlet end 11 of the oil supply line 1, by means of which a fluid-tight coupling of the device according to the invention to an oil-supplying component, such as in particular an oil supply line, can be achieved.

The embodiment according to FIGS. 1A and 1B further comprises a fastening element 5 which, in the preferred embodiment shown, comprises a threaded sleeve 51 for the load-bearing connection of the oil wetting device 10 to a motor vehicle component or to a load-bearing structure of a motor vehicle.

FIG. 2A shows the exemplary embodiment according to FIGS. 1A and 1B, wherein the oil wetting device 10 is designed as a two-shell plastic component and FIG. 2A shows only a first plastic shell part 41, which can be joined or connected in a fluid-tight manner to an opposite second plastic shell part 42, as shown in FIG. 2C, via at least one flat joining surface 40. The at least two plastic shell parts 41, 42 can be joined to one another with a material bond or are preferably joined to one another with a material bond. Corresponding joining processes for plastic material, in particular for thermoplastic materials, are known from prior art, such as ultrasonic welding or laser welding. Of course, a so-called assembly injection molding process can also be provided for joining the at least two plastic shell parts 41, 42.

FIGS. 2A-2C show in detail the configuration of the oscillator device 2, in particular the oscillation chamber 20, with the propelling nozzle 21 and the discharge nozzle 22 located opposite the propelling nozzle 21. In the FIGS. 2 shown, the discharge nozzle 22 is designed in the form of a fan nozzle 221 that expands in the direction of discharge of the oil, which expands in a fan shape in the oscillation plane 30 of the oil jet. In the embodiments shown, the propelling nozzle 21 is designed as a point nozzle for discharging a concentrated liquid oil jet into the oscillation chamber 20. A plurality of geometric structures 23 is formed in the oscillation chamber 20, so that in the oscillation chamber 20 in the embodiment shown, two control channels 24 are formed opposite each other in the oscillation plane 30. In the embodiment shown in FIGS. 2, the two opposing control channels 24 are mirror-symmetrical in the oscillation plane 30, in particular with the same flow cross-sections and courses. This achieves a uniform oscillation of the oil jet. However, it can also be provided, in particular, to form the illustrated channels 24 with different flow cross-sections, so that an oscillation of the oil jet in the oscillation plane 30 can be differently pronounced or formed in the two directions.

FIGS. 2A-2C show that the oil feed line 1 and the oscillator device 2 are designed transversely to the direction of flow of the oil from the inlet end 11 to the discharge nozzle 22 as a two-shell plastic component with two plastic shell parts 41, 42, wherein FIGS. 2A and 2B only show the first of the two plastic shell parts 41. In FIGS. 2, the flat joining surface 40 can be seen, via which the first and second plastic shell components 41, 42 can be connected or joined together in a fluid-tight manner. For illustration, the oil wetting device 10 comprising the two plastic shell components 41, 42 is shown in FIG. 2C, wherein the second plastic shell component 42 has been partially cut away in the area of the oscillation chamber 20 to illustrate the internal structures and the joining surface 40.

FIG. 3 again shows a perspective view of the exemplary embodiment of the oil wetting device 10 according to the invention, wherein the oscillating oil jet 3 is shown in FIG. 3, wherein this is shown as a plurality of oil droplets following directly one after the other.

FIG. 4 shows a perspective schematic view of a further exemplary embodiment of the oil wetting device 10 according to the invention. The exemplary embodiment according to FIG. 4 differs from the previous Figures in that the oil supply line 1 has an outlet end 12 opposite the inlet end 11, wherein the oscillator device 2 can be coupled to the oil supply line 1 in a fluid-tight manner in the area of the aforementioned outlet end 12. For this purpose, a fluid coupling is provided in the illustrated embodiment, which can be connected and coupled to each other without tools via latching elements. In the embodiment shown, the oil supply line 1 is designed as a single piece, for example as an injection-molded part, whereas the oscillator device 2 is in turn designed as a two-part shell component comprising a first shell part 41 and a second shell part 42 with a flat joining surface 40, via which the two plastic shell parts 41 and 42 of the oscillator device 2 can be connected or joined to one another in a fluid-tight manner.

What is claimed is:

1. Oil wetting device (10) for lubricating of motor vehicle components, comprising:
an oil supply line (1) with an inlet end (11) for supplying oil, and
an oscillator device (2) for emitting an oscillating oil jet (3);
wherein the oscillator device (2) is formed with an oscillation chamber (20) with a propelling nozzle (21) and a discharge nozzle (22) located downstream relative to the propelling nozzle (21);
wherein the propelling nozzle (21) is designed to discharge the oil supplied via the oil supply line (1) as a propelling jet into the oscillation chamber (20);
wherein geometric structures (23) are formed in the oscillation chamber (20) to form vortices, whereby the liquid propelling jet is caused to oscillate in a plane (30) when flowing through the oscillation chamber (20); and
wherein the discharge nozzle (22) is designed to discharge the oil jet (3) oscillating in the plane (30) from the oscillation chamber (20).

2. Oil wetting device (10) according to claim 1, wherein the propelling nozzle (21) is designed as a point nozzle for emitting a concentrated oil jet into the oscillation chamber (20).

3. Oil wetting device (10) according to claim 1, wherein at least two control channels (24) located opposite one another in the oscillation plane (30) are formed as geometric structures (23) in the oscillation chamber (20).

4. Oil wetting device (10) according to claim 1, wherein the discharge nozzle (22) is designed in the form of a fan nozzle (221), which is widened in a fan shape in the oscillation plane (30) of the oil jet (3).

5. Oil wetting device (10) according to claim 1, wherein the oil supply line (1) and the oscillator device (2) are made of a transmission oil-resistant plastic material.

6. Oil wetting device (10) according to claim 1, wherein the oil supply line (1) has an outlet end (12) opposite the inlet end (11), wherein the oscillator device (2) is formed by material bonding on the oil supply line (1) in the region of the outlet end (12), and wherein the propelling nozzle (21) is formed on the outlet end (12) of the oil supply line (1).

7. Oil wetting device (10) according to claim 1, wherein the oil supply line (1) has an outlet end (12) opposite the inlet end (11), wherein the oscillator device (2) is designed to be coupled to the oil supply line (1) in a fluid-tight manner in the region of the outlet end (12).

8. Oil wetting device (10) according to claim 1, wherein the oil supply line (1) and the oscillator device (2) are designed transversely to the direction of flow of the oil from the inlet end (11) to the discharge nozzle (22) as an at least two-shell injection-molded part with at least two plastic shell parts (41, 42).

9. Oil wetting device (10) according to claim 8, wherein the at least two-shell injection-molded plastic part has at least one flat joining surface (40).

10. Oil wetting device (10) according to claim 8, wherein the at least one first plastic shell part (41) is formed from a laser-transparent plastic material and wherein the at least one second plastic shell part (42) is formed from a laser-absorbing plastic material.

11. Oil wetting device (10) according to claim 8, wherein the at least two plastic shell parts (41, 42) are connected to each other by a materially bond, preferably joined to each other in a materially bonded manner.

12. Oil wetting device (10) according to claim 1, wherein the oil supply line (1) and the oscillator device (2) are designed along the direction of flow of the oil from the inlet end (11) to the discharge nozzle (22) as an integral injection molded plastic part.

13. Oil wetting device (10) according to claim 1, wherein a quick-coupling connection (111) is formed in the region of the inlet end (11) of the oil supply line (1) for fluid-tight coupling to an oil-carrying component.

14. Oil wetting device (10) according to claim 1, wherein a sealing element (14) is arranged or molded on, preferably formed, in the region of the inlet end (11) and/or, if present, the outlet end (12) of the oil supply line (1) for fluid-tight coupling of the oil supply line (1).

15. Oil wetting device (10) according to claim 1, wherein at least one fastening element (5) is formed in the region of the oil supply line (1) and/or the oscillator device (2) for the load-bearing connection of the oil wetting device (10) to a motor vehicle component.

16. Lubrication device for transmission components, preferably of an electrically powered vehicle, comprising:
at least one transmission component of a vehicle;
at least one oil-carrying component; and
at least one oil wetting device (10) according to claim 1,
wherein the at least one inlet end (11) of the at least one oil wetting device (10) is connected to the at least one oil-carrying component for supplying oil into the at least one oil supply line (1), and
wherein the at least one discharge nozzle (22) is aligned in the direction of the at least one transmission component for discharging an oscillating oil jet (3) onto the transmission component.

17. Transmission component of a vehicle, preferably an electric vehicle, comprising:
at least one oil-carrying component; and
at least one oil wetting device (10) according to claim 1,
wherein the at least one inlet end (11) of the at least one oil wetting device (10) is connected to the at least one oil-carrying component for supplying oil into the at least one oil supply line (1), and
wherein the at least one discharge nozzle (22) is aligned in the direction of the at least one transmission component for discharging an oscillating oil jet (3) onto the transmission component.

18. Oil wetting device (10) according to claim 5, wherein the transmission oil-resistant plastic material is glass fiber reinforced.

19. Oil wetting device (10) according to claim 15, wherein the at least one fastening element (5) comprises a threaded sleeve (51).
